(19) United States
(12) Patent Application Publication
(10) Pub. No.: US 2005/0101331 A1
(43) Pub. Date: May 12, 2005

(54) Method and system for controlling position detection of a terminal in a network

(75) Inventors: Tsuyoshi Tamaki, Hachioji (JP); Atsushi Ogino, Kodaira (JP); Takaki Uta, Kokubunji (JP); Ryota Yamasaki, Kokubunji (JP)

Correspondence Address: Stanley P. Fisher;Reed Smith LLP, Suite 1400, 3110 Fairview Park Drive, Falls Church, VA, 22042-4503, US

(73) Assignee: Hitachi, Ltd.

(21) Appl. No.: 10/867,717

(22) Filed: Jun. 16, 2004

(30) Foreign Application Priority Data
Oct. 16, 2003 (JP) 2003-355804

(51) Int. Cl. H04Q 7/20

(52) U.S. Cl. 455/456.1

(57) ABSTRACT

A method and system are provided for controlling position detection of a terminal in a network. In one example, a wireless communications system operates as a position determination system to determine the position of a terminal, based on the measurements of time difference of arrival (TDOA) of radio signals sent from the terminal and received at a plurality of base stations in the vicinity of the terminal, while preventing the loss of packets sent from terminals to the base stations.

### CLAIM OF PRIORITY

The present invention claims priority from Japanese application JP 2003-355804 filed on Oct. 16, 2003, the content of which is hereby incorporated by reference in its entirety.

### BACKGROUND OF THE INVENTION

1. Field of the Invention

The present invention relates to wireless communications systems, which can be used to determine the position of a mobile terminal or fixed terminal and methods for determining the terminal position in such systems.

2. Discussion of Background

In mobile communication systems typified by cellular mobile telephony systems, it is well known that a global positioning system (GPS) may be applied to determine a terminal position. Unfortunately, the method of determining a terminal position through GPS involves a problem that it is effective within the reach of radio waves from satellites, but the positioning accuracy drops in indoor environments or, more broadly, environments out of the reach of radio waves.

A method for solving this problem is described in JP-A No. 244967, which is summarized below. For a terminal and multiple base stations around it in a cellular system, the distances of the terminal from the base stations are calculated, based on the electric field strength of radio waves that the terminal receives from each base station. When the terminal communicates with a base station, its distance from the base station is calculated, based on the go-and-return propagation time of a radio signal from the terminal to the base station and back to the terminal. Using the distances thus calculated in two manners, the terminal position is determined by the principle of trilateration. The above distances calculated from the electric field strength of radio waves that the terminal receives from each base station have a large margin of error, depending on the conditions of radio propagation such as multi-paths and shadowing. This method improves the accuracy of positioning the terminal, using the distance calculated from the go-and-return propagation time of a radio signal, which has a little margin of error. However, the go-and-return propagation time of a radio signal can be obtained only between the terminal and the base station with which the terminal communicates. The distances of the terminal from other base stations in the vicinity of the terminal are calculated using the electric field strength of radio waves that the terminal receives from these base stations.

Ogino, et al. “Wireless LAN Integration Access System” in collected lecture papers B-5-203 for a general conference in March 2003 of the Institute of Electronics, Information and Communication Engineers suggests a similar method by using a wireless LAN (Local Area Network) system. In this method, by measuring the Time Difference of Arrival (TDOA) of radio waves from a terminal to multiple base stations there around, the terminal position is determined by way of the principle of triangulation (or trilateration). In this system, at all base stations in the vicinity of the terminal, the timing of receiving radio waves from the terminal is measured. Thus, the TDOA-based method of terminal position determination has features of a little margin of error of distance measurements and higher accuracy of positioning the terminal than the similar method by using the distances calculated from the electric field strength of radio waves that the terminal receives from each base station.

FIG. 1 shows the topology of the above wireless LAN integration access system. The system is comprised of a terminal 103a which is assumed to be the designated terminal to position, a base station 102d which is the home base station with which the terminal 103a primarily communicates, base stations 102a-102c which receive radio waves from the base station 102d and the terminal 203a, and a server 101. The server 101 calculates the distances between the terminal and each of the base stations 102a-102c from the TDOA measurements taken, based on data obtained from radio waves received at these base stations, and calculates the terminal position, according to the principle of trilateration.

In the above wireless LAN integration access system, the base stations 102a-102c provide basic functions to send and receive radio signals to/from the terminal 103a as the wireless LAN infrastructure when terminal position determination is not performed.

In FIG. 1, the server 101 transmits a positioning signal that is addressed to the terminal 103a and the base station 102d that received this positioning signal sends it as a radio signal to the terminal 103a. In reply to this positioning signal, the terminal 103a sends back a response to the positioning signal.

When the response to the positioning signal from the terminal 103a arrives at the base station 102c, the base station 102c has to stop communication with a terminal 103b connected to the base station 102c as its home and has to receive the response. If the base station 102c and the base station 102d use different frequency channels, the base station 102c has to switch to the frequency channel for the base station 102d in order to receive the response to the positioning signal from the terminal 103a. Consequently, a period during which the base station 102c uses the frequency channel for receiving the positioning signal is equivalent to the period during which the base station 102c is absent for the terminal 103b.

Unfortunately, this absence causes a problem of loss of data packets transmitted from the terminal 103b during this period. Particularly, for communication using Transmission Control Protocol (TCP) as a general-purpose transfer protocol on the Internet, it takes a while to detect the loss of a packet that is transmitted when a communication link is established initially. Thus, this delay leads to response degradation for users, that is, it is hard to set up communication.

Because there is a high probability that the base station 102d and the base station 102c are located physically nearby, they are often operated with different frequency channels in order to avoid a decrease in communication speed because of mutual interference. The server 101 can grasp when and how often terminal position determination is performed, whereas the terminals 103a and 103b cannot do such a task.

Unfortunately, there is a high probability that the base station 102c switches to the frequency channel that the base station 102b uses without notifying the terminal 103d of the channel switching.

### SUMMARY OF THE INVENTION

There is a need for a mechanism to solve the problem of loss of packets transmitted from a terminal, resulting from channel switching amongst base stations. For wireless LAN terminals that have already been available on the market, a system with mechanisms that address this problem, while supporting backward compatibility, is desirable.

In order to solve the above problems, in a wireless communications system in which the present invention is applied, the present invention provides a method for controlling position determination. In order to determine the position of a particular terminal, the method comprises means for taking TDOA measurements of radio signals sent from the terminal to position and received at a plurality of base stations in the vicinity of the terminal to position, means for calculating the terminal position from the TDOA measurements by the principle of trilateration, means for notifying terminals connected to the plurality of base stations as their home ones in the vicinity of the terminal to position of an interruption time of communication (a period of interruption of communication) between the plurality of base stations and the terminals connected to the base stations, and means for inhibiting the terminals connected to the base stations from transmitting packets for the time notified, wherein the time during which the terminals are inhibited from transmitting packets is set longer than a time during which the base stations use an alternate frequency channel for taking the TDOA measurements.

To allow existing LAN terminals to support backward compatibility, existing mechanisms to inhibit the terminals from transmitting packets must be used. For example, when receiving an RTS (Request to Send) control signal or a CTS (Clear to Send) control signal, defined in the IEEE802.11 Standards, it is prescribed that transmission be inhibited as long as the time specified in the RTS or CTS control signal. Accordingly, it is advisable that the base stations transmit the RTS control signal or CTS control signal to the terminals to inhibit the terminals from transmitting packets for a given period. Thus, the present invention is made effective for existing wireless LAN terminals as well.

According to the present invention, in the method for determining the position of a terminal by using the TDOA measurements of radio signals sent from the terminal and received at the plurality of base stations in the vicinity of the terminal, other terminals connected to the base stations as their home ones are inhibited from transmitting packets. Meanwhile, the base stations in the vicinity of the terminal are engaged in taking the TDOA measurements, using an alternate frequency channel for the measurements after switched to from their original channels. In this way, the loss of the packets from the terminals to the base stations during position determination can be prevented.

Particularly, for applications required to determine the positions of a great number of terminals per unit time, the aggregate time occupied for position determination may increase greater than the total time when the base stations operate as the wireless infrastructure. Even if the base stations frequently make switchover to the alternate frequency channel, there is no increase in the rate of loss of packets from the terminals to the base stations.

According to the present invention, without adding a special function to existing terminals available on the market, the invention prevents the loss of packets transmitted from the terminals other than the terminal to position.

The invention encompasses other embodiments of a method, an apparatus, and a system, which are configured as set forth above and with other features and alternatives.

### BRIEF DESCRIPTION OF THE DRAWINGS

The present invention will be readily understood by the following detailed description in conjunction with the accompanying drawings. To facilitate this description, like reference numerals designate like structural elements.

FIG. 1 is a wireless communications system topology and a schematic diagram of a system for effecting terminal position determination;

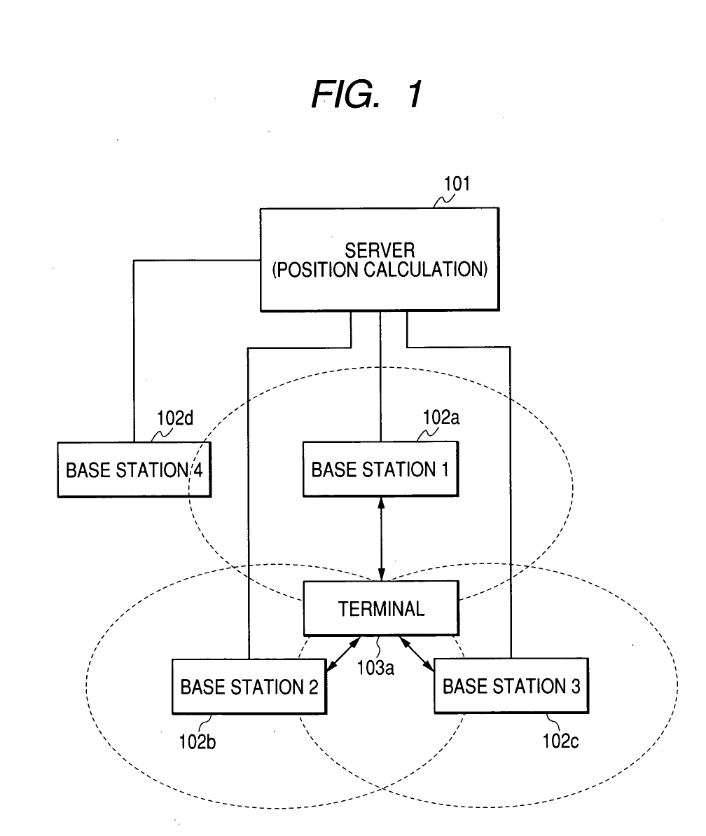

FIG. 2 is a more detailed wireless communications system schematic diagram for controlling terminal position determination;

FIG. 3 is a sequence chart of position determination control flow;

FIG. 4 is a sequence chart of position determination control flow, in accordance with an embodiment of the present invention;

FIG. 5 shows the format of a control signal for position determination, in accordance with an embodiment of the present invention;

FIG. 6 is a flowchart describing an algorithm to be executed by a base station's control unit, in accordance with an embodiment of the present invention;

FIG. 7 is a flowchart describing the detail of a base station's control procedure for terminal position determination included in the algorithm to be executed by a base station's control unit, in accordance with an embodiment of the present invention;

FIG. 8 is a flowchart describing an algorithm to be executed by the server's control unit, in accordance with an embodiment of the present invention; and

FIG. 9 is a flowchart describing the detail of a server's control procedure for terminal position determination included in the algorithm to be executed by the server's control unit, in accordance with an embodiment of the present invention.

### DESCRIPTION OF THE PREFERRED EMBODIMENTS

An invention for a method and system for controlling position detection of a terminal in a network is disclosed. Numerous specific details are set forth in order to provide a thorough understanding of the present invention. It will be understood, however, to one skilled in the art, that the present invention may be practiced with other specific details.

General Overview

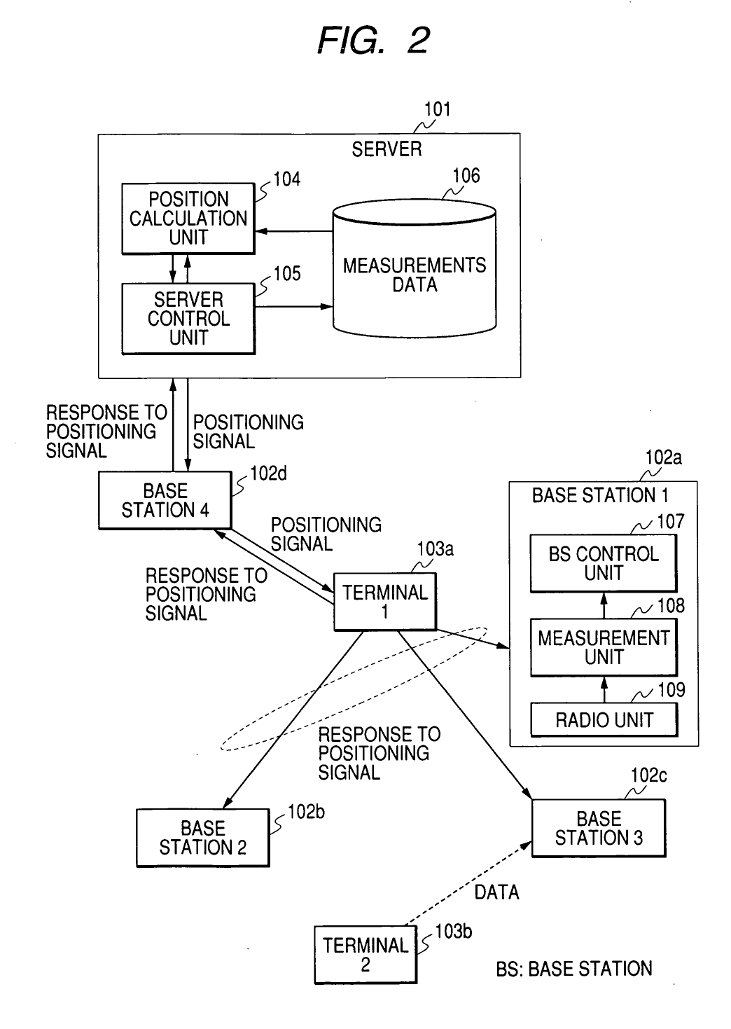

FIG. 2 generally outlines an operation of terminal position determination. The server 101 transmits a positioning signal that is addressed to the terminal 103a and the base station 102d that received this positioning signal sends it as a radio signal to the terminal 103a. In reply to this positioning signal, the terminal 103a sends back a response to the positioning signal. The base stations 102a, 102b, 102c in the vicinity of the terminal 103a receive this response to the positioning signal through their radio units 109. Their measurement units 108 create measurement data and the base station control units 107 make the base stations send the measurement data to the server 101. On the server 101, the server control unit 105 stores the measurement data from the base stations into a measurement data 106 file and the position calculation unit 104 calculates the position of the terminal 103a, using the measurement data 106.

When the response to the positioning signal from the terminal 103a arrives at the base station 102c, the base station 102c has to stop communication with a terminal 103b connected to the base station 102c as its home and has to receive the response. If the base station 102c and the base station 102d use different frequency channels, the base station 102c has to switch to the frequency channel for the base station 102d in order to receive the response to the positioning signal from the terminal 103a. Consequently, in conventional systems, a period during which the base station 102c uses the frequency channel for receiving the positioning signal is equivalent to the period during which the base station 102c is absent for the terminal 103b.

### More Detail Of Preferred Embodiments

Preferred embodiments of the present invention will be described hereinafter with reference to the accompanying drawings.

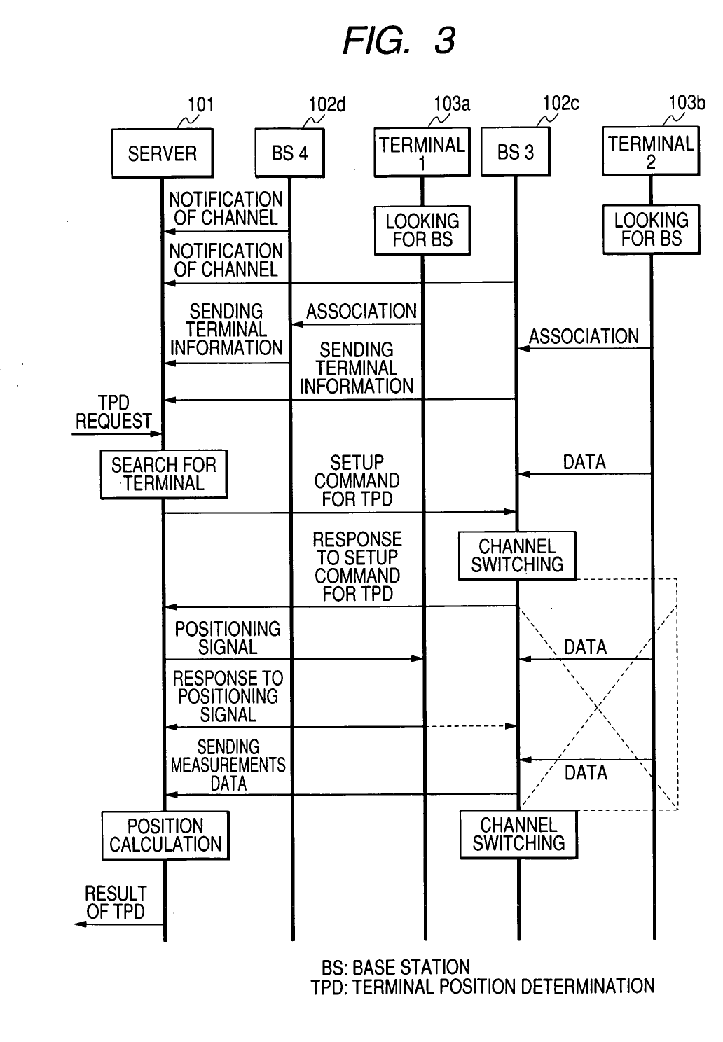

FIG. 3 shows a general sequence chart of a position determination control flow. For information necessary for position determination, the server needs to know beforehand the base station to which a terminal to position is connected as its home one and the frequency channels assigned to the base stations in the vicinity of the terminal in order to communicate with terminals connected to the base stations. The procedure for collecting this information will be described below.

After booting up and completing the setup for basic operation, each base station 102c, 102d sends the notification of a frequency channel that it uses for communication to the server 101 through a control signal. Each terminal 103a, 103b looks for a base station which is regarded as the best in terms of communication conditions and sends an association control signal to the base station to notify the base station that it is getting connected thereto as its home one. Having received the association control signal, the base stations 102c, 102d send terminal information reporting control signals to the server 101. In this way, the above information necessary for position determination is stored on the server 101.

The following will describe the operation after an application for position determination service issues a terminal position determination request to the server 101 and until obtaining the result of terminal position determination.

When receiving the terminal 103a position determination request, the server 101 searches for information about the terminal 103a to position. The server 101 sends the channel information for the base station 102d to which the terminal is connected as its home one to the base stations 102a-102c in the vicinity of the terminal 103a to position. The server 101 performs this sending through control signals of setup commands for terminal position determination. Upon having received the control signals of setup command for terminal position determination, the base station 102c switches the channel to an alternate channel for terminal position determination. The switching occurs so that the base station 102c can receive a response to a positioning signal, sent from the terminal 103a. The base station 102c also sends back a response to the setup command for terminal position determination to the server 101. When the server 101 receives the responses to the setup command for terminal position determination from all base stations in the vicinity of the terminal 103a, the server transmits a positioning signal, and the terminal 103a sends back response signals to the positioning signal.

For example, if the terminal 103a is compliant with an Internet Control Message Protocol (ICMP) and provided with an ICMP Echo function as standard, Ping Request and Ping Response signals may be used as the above positioning signal and its responses.

When each base station 102a-102c in the vicinity of the terminal receives the response to the positioning signal, each sends measurement data, corresponding to time information when the response signal arrived at the base station, to the server 101. Also, each base station 102a-102c switches the frequency channel back to its original channel. The server 101 calculates the terminal position, according to the principle of trilateration, based on the information contained in the measurement data reporting control signals received from the base stations in the vicinity of the terminal.

Here, if the terminal 103b is transmitting a sequence of data packets to base station 102c at this time, the base station 102 cannot receive the data packets sent from the terminal 103b. Thus, the data packets are lost while awaiting an incoming response to the positioning signal in the above-described position determination control flow. This loss occurs because the base station 102c uses the alternate frequency channel after switching.

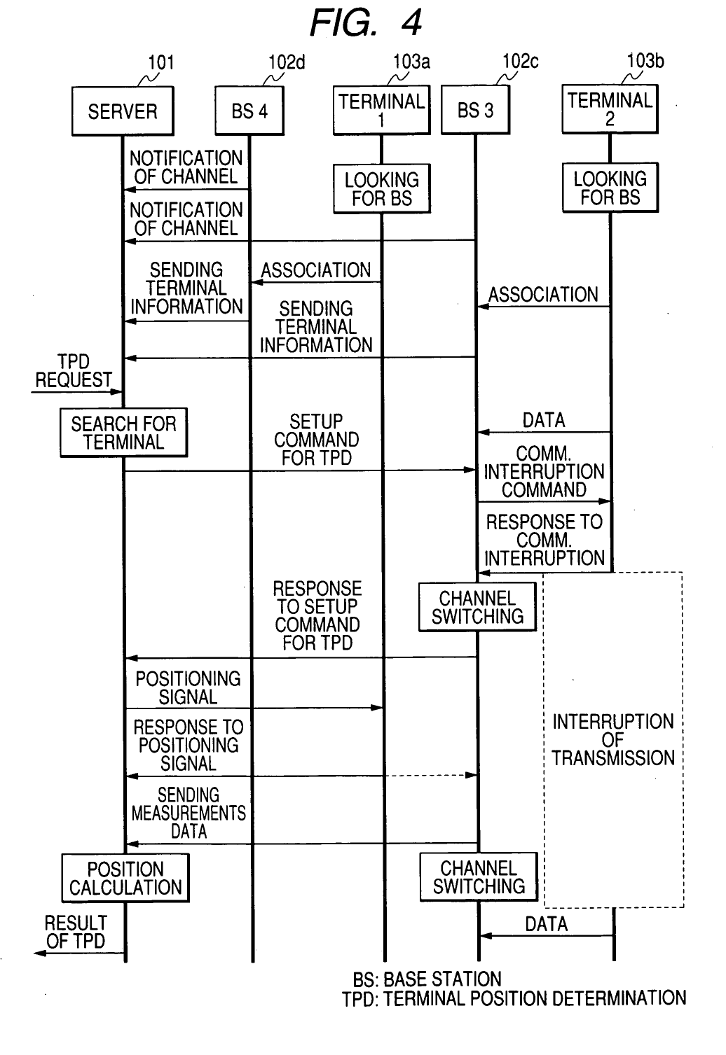

FIG. 4 shows a sequence chart of position determination control flow, in accordance with an embodiment of the present invention. The difference from the position determination control flow shown in FIG. 3 is that the base station 102c sends a control signal of a communication interruption command specifying interruption time of communication to the terminal 103b before channel switching.

When the terminal 103b returns a control signal of a response to communication interruption to the base station 102c, the base station 102 makes sure that the interruption time of communication has been conveyed to the terminal 103b. For example, the RTS control signal or CTS control signal defined in the IEEE802.11 standards may be used as the communication interruption command control signal and, in that case, the base station need not receive the communication interruption response control signal.

The base station 102c obtains the interruption time of communication by referring to information indicating the interruption time of communication included in the control signal of setup command for terminal position determination from the server 101. Alternatively, the interruption time of communication may be determined by a parameter assigned beforehand on the base station 102c. However, by choosing the manner in which this information is obtained from the server 101, the interruption time of communication can be managed consistently throughout the system.

The terminal 103b enters a transmit disable state not to transmit data packets and remains idle during the specified interruption time of communication. Upon the elapse of the interruption time of communication, the terminal 103b resumes transmitting data packets. At this time, the base station 102c returns to the original frequency channel operation. Accordingly, no data packet loss occurs after the terminal 103b resumes transmitting data packets. To ensure that the mode of terminal position determination terminates upon the elapse of the interruption time of communication, it is advisable to set the interruption time of communication longer than time required to complete the terminal position determination, allowing for time required to send and receive the communication interruption command and response signals.

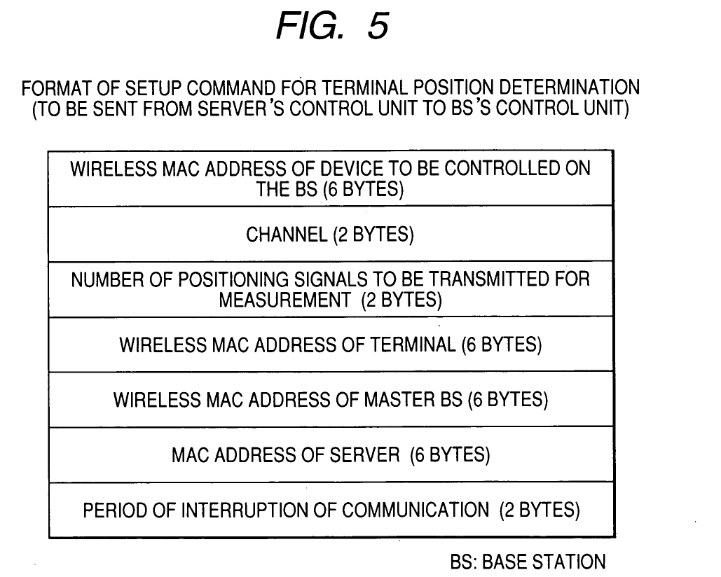

FIG. 5 shows the format of the control signal of setup command for terminal position determination, in accordance with an embodiment of the present invention. This control signal is sent from the server's control unit 105 to the control units 107 of the base stations in the vicinity of the terminal to position.

Referring to FIG. 5, the setup command signal format consists of seven fields. The first field is wireless MAC (Media Access Control) address of device to be controlled on the base station. This field contains an ID that is used to identify which wireless LAN hardware device to be set up, if the base station has a plurality of wireless LAN hardware devices.

The second field is channel. In this field, a channel to be switched to, in other words, the frequency channel for positioning signal transmission, is specified.

The third field is the number of positioning signals to be transmitted for measurement. In this field, the number of positioning signals that the server will transmit to the terminal is specified. This value is used for the base station to receive as many responses as the specified number of positioning signals and send data of aggregate measurements on the responses to the server.

The fifth field is wireless MAC address of master base station. This field contains the MAC address of the wireless LAN hardware device of the base station to which the terminal to position is connected as its home one.

The base stations 102a-102c compare the wireless MAC address of the terminal and the wireless MAC address of the master base station with the corresponding addresses specified in the MAC header of a received signal at the base stations. Thereby, the base stations can identify positioning signal response control signals. Besides the above-mentioned two MAC addresses, the MAC address of the server may be used.

The seventh field is period of interruption of communication. In this field, while the terminal connected to the base station as its home one, the terminal is inhibited from communicating with the base station as long as the base station is engaged in position determination operation. In this way, the interruption time of communication is included in the control signal of setup command for terminal position determination. Alternatively, the interruption time of communication may be assigned beforehand on the base stations, as described above, or may be determined according to the number of positioning signals to be transmitted for measurement.

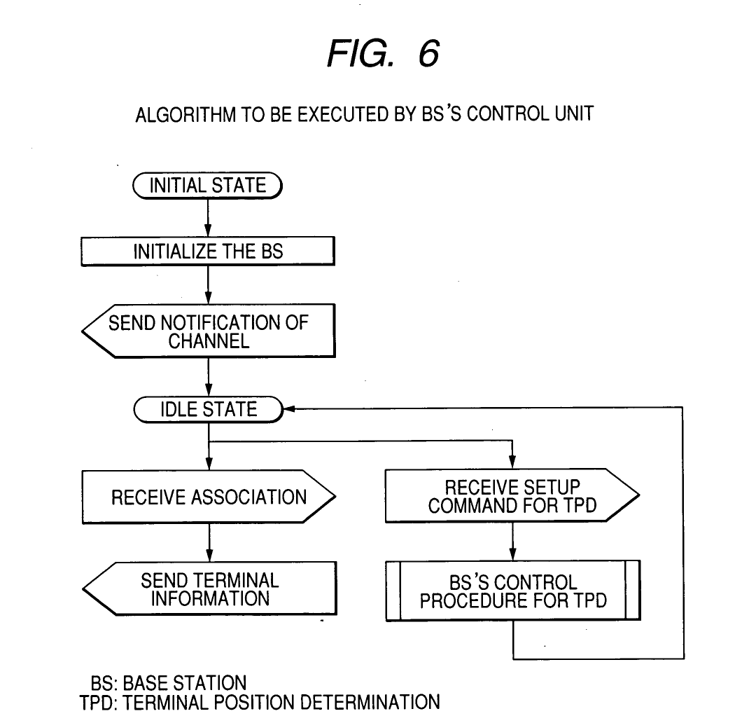

FIG. 6 shows an algorithm to be executed by the control units 107 of the base stations in the vicinity of the terminal to position, in accordance with an embodiment of the present invention. When each base station is powered on or reset, the base station is initialized and enters an initial state. The initialization completes port setting for communication with the server, frequency channel setting of the wireless LAN hardware device of the base station, and other setting. Then, the base station notifies the server of the set frequency channel by sending a channel notification control signal and enters an idle state awaiting an event.

In the idle state, when receiving an association control signal from a terminal, the base station notifies the server of the wireless MAC address of the terminal as well as the MAC address of the wireless LAN hardware device of the base station, selected by the terminal, by sending a terminal information reporting control signal. The server then returns to the idle state.

When receiving a control signal of setup command for terminal position determination from the server, the base station executes a base station's control procedure for terminal position determination, which will be described below. The base station then returns to the idle state.

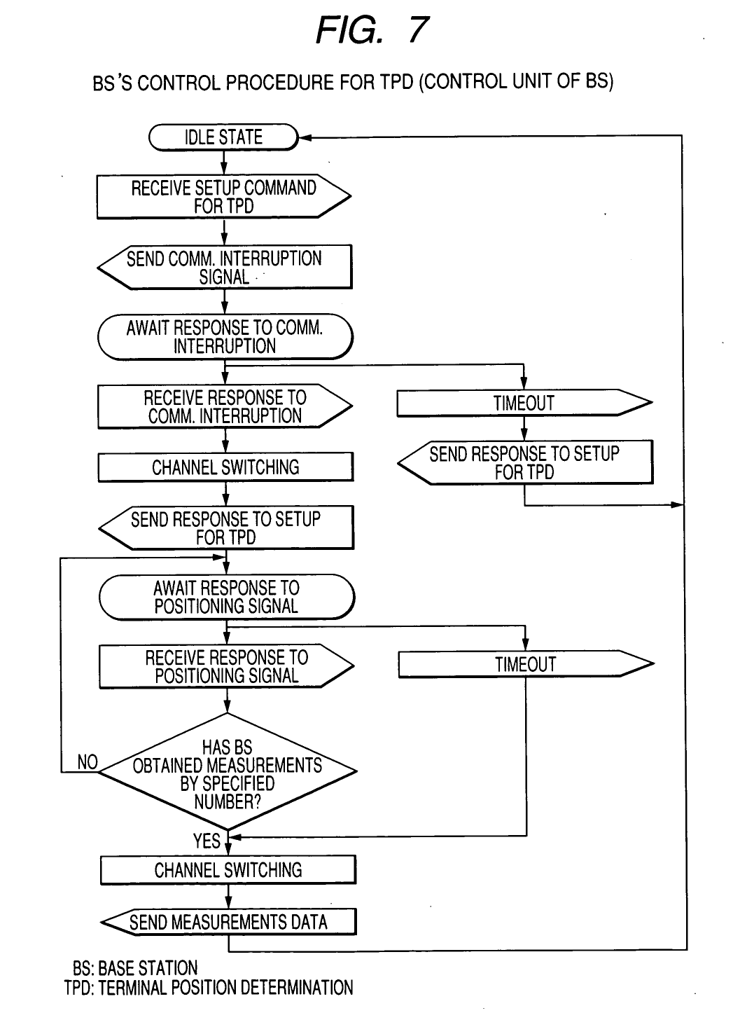

FIG. 7 shows the algorithm of the base station's control procedure for terminal position determination, in accordance with an embodiment of the present invention. When receiving a setup command for terminal position determination in the idle state, the base station sends a communication interruption control signal to a terminal connected to it. The base station then awaits a control signal of a response to communication interruption from the terminal. If timeout occurs and the base station fails to receive the response to communication interruption from the terminal, then the base station notifies the server of setup failure by a control signal of a response to setup for terminal position determination. If the base station successfully receives the control signal of response to communication interruption from the terminal, then the base station switches to the channel specified in the setup command for terminal position determination, notifies the server of successful setup by the control signal of response to setup for terminal position determination, and enters a state awaiting the reception of a control signal of a response to positioning signal from the terminal to position. The base station collects as many control signals of responses to positioning signals as the number of positioning signals specified in the setup command for terminal position determination or measures the response signals until timeout occurs, and upon the termination of measurement, the base station returns to the original channel used before the position determination operation. Then, the base station notifies the server of the measurement result by a measurement data reporting control signal and returns to the idle state.

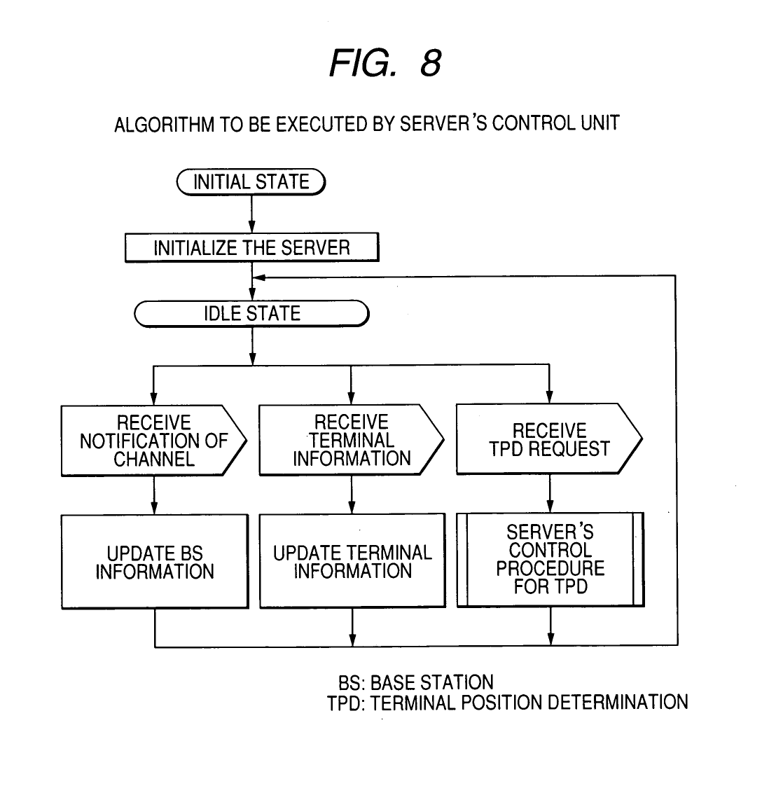

FIG. 8 shows an algorithm to be executed by the server's control unit 105, in accordance with an embodiment of the present invention. When the server is powered on or reset, the server enters the initial state, and, after being initialized, enters an idle state awaiting an event. The initialization completes port setting for communication with base stations and other settings.

In the idle state, when receiving a channel notification control signal from a base station, the server updates base station information by storing a mapping of the MAC address of the wireless LAN hardware device of the base station that sent the channel notification and the frequency channel that the base station uses as frequency channel information into a storage device. The server then returns to the idle state.

In the idle state, when receiving a terminal information reporting control signal from a base station, the server updates terminal information by storing a mapping of the MAC address of the wireless LAN hardware device of the base station that sent the terminal information and the MAC address of the wireless LAN hardware device of the terminal connected to the base station as its home one into the storage device. The server then returns to the idle state.

When storing the above data into the storage device to update base station information and terminal information, the server searches for data that matches the MAC address of the wireless LAN hardware device of the base station. If matching data exists, the server overwrites the data to update it. The matching data does not exist, the server generates new data.

In the idle state, when receiving a terminal position determination request from the position determination service application, the server executes a server's control procedure for terminal position determination, which will be described below. The server then returns to the idle state.

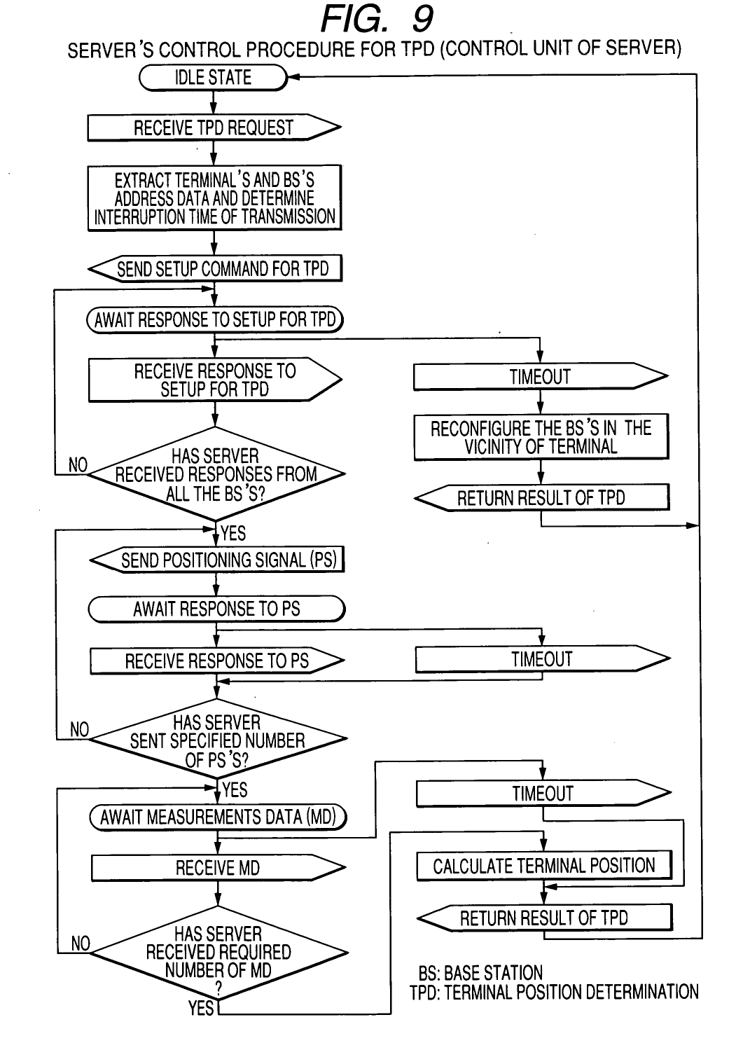

FIG. 9 shows the algorithm of the server's control procedure for terminal position determination, in accordance with an embodiment of the present invention. In the idle state, when receiving the terminal position determination request from the position determination service application, the server identifies the terminal to position. The server also searches the frequency channel data stored in the storage device to extract the MAC address of the wireless LAN hardware device of the terminal, the MAC address of the wireless LAN hardware device of the base station to which the terminal is connected as its home one, and the MAC addresses of the wireless LAN hardware devices of the base stations in the vicinity of the terminal. The server determines the time during which to inhibit the terminal from transmitting by T1+n×T2. Here, the parameters have the following meanings: n is the number of base stations in the vicinity of the terminal; T1 is a fixed portion of time required to determine the terminal position, which is independent of the number of base stations in the vicinity of the terminal; and T2 is the remaining portion of time required to determine the terminal position, which is dependent on the number of base stations in the vicinity of the terminal.

The number of base stations in the vicinity of the terminal is a count of base stations that can well receive radio waves from the terminal. The fixed portion of the time independent of the number of base stations involves, for example, time required to send and receive positioning signals and their response signals. The time dependent on the number of base stations involves time required to send and receive response signals to setup for terminal position determination and measurement data reporting signals transmitted from the base stations to the server.

For an alternative, when a base station sends a terminal information signal, the terminal information may involve the MAC addresses of terminals associated with other base stations, so that, based on that information, the server can identify base stations in the vicinity of the terminal. Alternatively, based on the coordinates of the base stations obtained when the base stations were installed, the server may determine base stations within a certain range from the terminal as those in the vicinity of the terminal.

The server sends control signals of setup commands for terminal position determination containing the above-described items of information to the base stations in the vicinity of the terminal and enters a state awaiting responses to setup for terminal position determination.

If timeout occurs and the server cannot receive the control signals of responses to setup for terminal position determination from all the base stations in the vicinity of the terminal, then the server deletes one or more base stations that have not sent back the above responses to setup from the list of the base stations in the vicinity of the terminal, returns an unsuccessful result of terminal position determination to the application, and returns to the idle state.

If the server successfully receives the above responses to setup from all the base stations in the vicinity of the terminal, then the server sends a positioning signal and enters a state awaiting responses to the positioning signal. If the server receives the responses to the positioning signal or timeout occurs, then the server checks whether it has sent the specified number of positioning signals for measurement. If the server has not yet sent the specified number of positioning signals, then the server continues to send positioning signals until it finishes sending the specified number of positioning signals.

Upon having finished sending the specified number of positioning signals for measurement, the server awaits measurement data reporting control signals from the base stations in the vicinity of the terminal. If the server has received the required number of measurements data to calculate the terminal position, then the server calculates the terminal position from the measurements data according to the principle of trilateration, returns the thus obtained result of terminal position determination to the application, and returns to the idle state. If timeout occurs and the server has not yet collected the required number of measurements data to calculate the terminal position, the server returns an unsuccessful result of terminal position determination to the application, and returns to the idle state.

Among wireless LAN communications systems, a system that performs position determination, while providing the basic functions of base stations as wireless LAN communications infrastructure, has a very high probability of taking advantage of the present invention. Industrial applicability of a wireless LAN based position determination system as disclosed herein includes the management of goods in warehouses related to physical distribution, an indoor navigation system at an international exhibition hall, and other applications.

In the foregoing specification, the invention has been described with reference to specific embodiments thereof. It will, however, be evident that various modifications and changes may be made thereto without departing from the broader spirit and scope of the invention. The specification and drawings are, accordingly, to be regarded in an illustrative rather than a restrictive sense.

1. A method for position determination of a designated terminal in a system for wireless communications, the system having a plurality of base stations configured to communicate with the designated terminal and a server connected to the plurality of base stations via a network, wherein the system is configured to send and receive positioning signals and their responses between a one base station of the plurality of base stations and the designated terminal, to measure timings of receiving the responses to the positioning signals at other plurality of base stations other than the one base station, and to calculate a position of the designated terminal using the timings measured, the method comprising:
communicating, via respective communication channels of the plurality of base stations, with each terminal connected to a base station as its home base station, the communication channels being different from a positioning signal channel that is used for the one base station to communicate with the designated terminal;
sending, via the server, setup commands for terminal position determination to the other plurality of base stations prior to starting to send the positioning signals to the designated terminal;
receiving the setup commands for terminal position determination;
sending communication interruption signals to inhibit the terminals connected to base stations from communicating with their home base stations;
making channel switchovers from respective communication channels to the positioning signal channel;
receiving positioning response signals to the positioning signals and respective responses which are sent and received between the one base station-and the designated terminal;
sending measurements data on the positioning response signals received to the server; and
switching the positioning signal channel back to the communication channels, wherein the communication interruption signals notify the terminals connected to the other plurality of base stations of an interruption time of communication during which the terminals are inhibited from communicating with their home base stations.

2. The method of claim 1, further comprising specifying, via the server, the interruption time of communication in the setup commands for terminal position determination to be sent to the other plurality of base stations.

3. The method of claim 1, wherein the interruption time of communication is longer than a time required to send and receive the positioning signals and their responses between the one base station and the designated terminal.

4. The method of claim 1, further comprising:
sending, via the terminals connected to the other plurality of base stations, response signals to communication interruption when receiving the communication interruption signals; and
switching over, via the other plurality of base stations, to the positioning signal channel after making sure of receiving the response signals to communication interruption from the terminals connected thereto.

5. The method of claim 1, wherein the system for wireless communications is configured to perform wireless communication according to a wireless LAN (Local Area Network) protocol, and wherein the communication interruption signals are RTS (Request to Send) or CTS (Clear to Send) control signals.

6. A system for position determination of a designated terminal in a system for wireless communications, wherein the system is configured to send and receive positioning signals and their responses between a one base station of the plurality of base stations and the designated terminal, to measure timings of receiving the responses to the positioning signals at other plurality of base stations other than the one base station, and to calculate a position of the designated terminal using the timings measured, the system comprising:
terminals including the designated terminal;
a plurality of base stations including the one base station and the other plurality of base stations; and
a server to which the plurality of base stations are connected via a network,
the server comprising a storage device and a server control unit, wherein the storage device is configured to store information obtained per base station about channels which are normally used by the plurality of base stations and terminals connected to the base stations as their home ones, wherein the server control unit is configured, when receiving any terminal position determination request, to retrieve the base station to which the designated terminal is connected as its home one from the storage device, to set the base station for the one base station, to retrieve a channel which is used by the one base station, to set the channel for a positioning signal channel, to send setup command signals for terminal position determination including the positioning signal channel information to the other plurality of base stations, to command the one base station to send and receive positioning signals and their responses by receiving response signals to setup commands for terminal position determination, and to calculate the position of the designated terminal by using measurements data on the timings of receiving the positioning responses at the other plurality of base stations collected from the base stations,
the other plurality of base stations being configured, when receiving the setup command signals for terminal position determination, to send communication interruption signals to inhibit the terminals connected thereto from communicating with their home base stations to the terminals through their respective communication channels, to send response signals to the setup command signals to the server, to switch their channels in normal use to the positioning signal channel, to receive response signals to the positioning signals and their responses which are sent and received between the one base station and the designated terminal, to send measurements data on the received response signals to the server, and to switch the channel back to the communication channels,
wherein the communication interruption signals notify the terminals connected to the other plurality of base stations of an interruption time of communication during which the terminals are inhibited from communicating with their home base stations.

7. The system of claim 6, wherein the server is configured to specify the interruption time of communication in the setup commands for terminal position determination to be sent to the other plurality of base stations.

8. The system of claim 6, wherein the interruption time of communication is longer than a time required to send and receive the positioning signals and their responses between the one base station and the designated terminal.

9. The system of claim 6, wherein the terminals connected to the other plurality of base stations are configured, when receiving the communication interruption signals, to send response signals to communication interruption, and wherein the other plurality of base stations are configured to switch over to the positioning signal channel after making sure of receiving the response signals to communication interruption from the terminals connected thereto.

10. The system of claim 6, wherein the system is configured to perform wireless communication according to a wireless LAN (Local Area Network) protocol, and wherein the communication interruption signals are RTS (Request to Send) or CTS (Clear to Send) control signals.

11. A base station configured to be in a position determination system including terminals having a designated terminal, a plurality of base stations configured to communicate with the designated terminal, and a server connected to the plurality of base stations via a network, wherein the system is configured to send and receive positioning signals and their responses between one base station of the plurality of base stations and the designated terminal, to measure timings of receiving the responses to the positioning signals at other plurality of base stations other than the one base station, and to calculate a position of the designated terminal using the timings measured, wherein the base station functions as one of the other plurality of base stations, the base station comprising:
a radio unit configured to send and receive radio signals;
a communication unit configured to perform communications with the server; and
a base station control unit,
wherein the radio unit is configured to communicate with a terminal connected to the base station as its home one through a communication channel different from a positioning signal channel which is used for the one base station to communicate with the designated terminal,
wherein the base station control unit is configured, when receiving a setup signal for terminal position determination including the positioning signal channel information from the server, to generate a communication interruption signal that inhibits the terminal connected to the base station from communicating with the base station;
wherein the radio unit is configured to send the communication interruption signal to the terminal through the communication channel, to switch the channel in use from the communication channel to the positioning signal channel, to receive response signals to the positioning signals and their responses which are sent and received between the one base station and the designated terminal, and to switch the channel in use back to the communication channel,
wherein the communication unit is configured to send measurements data on the received response signals to the server, and
wherein the communication interruption signal notifies the terminal connected to the base station as one of the other plurality of base stations of an interruption time of communication during which the terminal is inhibited from communicating with the home base station.

12. The base station of claim 11, wherein the interruption time of communication is determined according to information included in the setup signal for terminal position determination.

13. The base station of claim 11, wherein the interruption time of communication is longer than a time required to send and receive the positioning signals and their responses between the one base station and the designated terminal.

14. The base station of claim 11, wherein the radio unit is further configured to switch the channel to the positioning signal channel after confirming receipt of a response signal to the communication interruption from the terminal connected to the base station.

15. The base station of claim 11, wherein the base station is configured to perform wireless communication according to a wireless LAN (Local Area Network) protocol, and wherein the communication interruption signal is an RTS (Request to Send) or CTS (Clear to Send) control signal.
